(19) United States
(12) Patent Application Publication
(10) Pub. No.: US 2008/0016442 A1
(43) Pub. Date: Jan. 17, 2008

(54) Electronic Location Calendar

(76) Inventor: Denis Khoo, Arcadia, CA (US)

Correspondence Address: DENIS KHOO, 9729 CAMINO REAL, ARCADIA, CA, 91007, US

(21) Appl. No.: 11/781,951

(22) Filed: Jul. 24, 2007

Related U.S. Application Data
(63) Continuation-in-part of application No. 10/884,357, filed on Jul. 2, 2004.

(51) Int. Cl. G06F 3/00

(52) U.S. Cl. 715/700

(57) ABSTRACT

A method and system is described for providing a traveler with the ability to query an electronic social network for travel related information, using an electronic location calendar. The traveler, and related individuals, enter future travel plans into the system, and the system will provide a graphical representation on an electronic location calendar. The traveler leverages this electronic location calendar to query the system in determining which related individuals will be at the same travel location for a future date. The traveler is also able to query the system to determine when next a related individual will be at a particular location. The travel can also query the system to determine where related individuals will be for a future date.

This is a Continuation-in-Part of application Ser. No. 10/884,357, filed Jul. 2, 2004.

### BACKGROUND OF THE INVENTION

1. Field of the Invention

The present invention relates generally to an electronic location calendar, and more particularly, to an electronic location calendar which displays an individual's location.

2. Description of the Related Art

Several decades ago, most people considered traveling out of town a rare event. However, in today's high tech and fast paced environment, individuals find themselves traveling much more frequently for both business and pleasure. Also contributing to the increase in out of town travel is the lowered cost of travel and the increased efficiency of travel. Individuals now have several modes of travel to choose from, including car, boat, train, and plane.

Travelers, especially business travelers, are finding themselves traveling alone and for extended periods. They are also finding that they are traveling to destinations completely foreign and unfamiliar to them. Whether or not they are traveling alone, travelers typically would like the opportunity to find and meet with related individuals, such as friends, family members, business associates, or even friends of friends while at their travel destination.

Typically, in order to accomplish this task, the traveler would first have to perform the step 100 of keeping track of related individuals by using a paper or electronic organizer. Upon completing the step 110 of determining travel plans, the traveler must then perform the step 120 of contacting each related individual in order to determine if that related individual will be at the same location within the same date range. If the related individual's contact information is out of date, the traveler needs to take the additional step 150 of figuring out the updated contact information. Once the step 140 of contacting the related individual is completed, the traveler can determine whether or not the related individual will be at the same location within the same date range. If so, the traveler can then take the step 170 of noting this and making arrangements to meet with the related individual.

There is a need for a more convenient way of allowing a traveler to discover related individuals that a traveler can meet with. A traveler should be able to easily discover which related individuals, if any, will be at the destination at the same time that the traveler will be. The traveler should not have to personally contact every friend, family member, business associate, etc., to discover this information as they would today. Once the traveler discovers which related individuals will be in the same geographical proximity on a given date, the traveler can then contact those related individuals and make arrangements to meet.

In order to achieve the goals stated above, the present invention leverages the popularity of online social networks. There are several online social networks on the internet today, such as Friendster, Orkut, and Plaxo. An online social network allows an individual to easily keep track of relationships that the individual has with other people by leveraging the internet. Each individual maintains his or her own account profile on the online social network, and defines who his or her related individuals are. Once defined, the online social network retains the relationship.

FIG. 4a, FIG. 4b, FIG. 4c, FIG. 4d, and FIG. 4e represent relationship diagrams to provide a better understanding of online social networks. In this example, all relationships are symmetrical, meaning if User A 400 is a related individual of User B 410, then User B 410 must be a related individual of User A 400. An online social network need not have such a symmetrical relationship. In FIG. 4a, User A 400 defines his relationship with three related individuals, User B 410, User C 420, and User D 430. Each of these three related individuals have their own relationship to their own related individuals. The relationship diagram in FIG. 4b reveals User B's 410 related individuals. As shown, User B's related individuals are User A 400, User C 420, User E 440, and User F 450. FIG. 4c shows that User C's 420 related individuals are User A 400, User B 410, User F 450, and User G 460. FIG. 4d shows that User D's 430 related individuals are User A 400, User G 460, User H 470, User I 480, and User J 490. In FIG. 4e, User A's 400 related individuals are shown, with up to one degree of separation. User A's 400 related individuals at zero degree of separation include User B 410, User C, 420, and User D 430. User A's 400 related individuals at one degree of separation include User E 440, User F 450, User G 460, User H 470, User I 480, and User J 490.

The advantages of an electronic social network are numerous. An electronic social network is able to maintain a list of related individuals for a member. Since an electronic social network stores a relationship (or link) to a related individual from a member, data about a related individual is managed by the related individual. For example, the electronic social network keeps a link between User A and User B. If User A's phone number changes, there is no need for User B to make the update. User A updates his/her phone number on the electronic social network, and the update is automatically reflected to User B. Similarly, the electronic social network also has a link between User A and User C, and thus User C would also sees User A's new phone number. Another advantage of an electronic social network is the ability to see related individuals at multiple levels of separation. Users of the electronic social network can see friends of friends, or others within one degree of separation. Of course, viewing users at more than one degree of separation is also possible.

Another technology that this invention builds upon is an electronic calendar. There are several electronic calendars in existence today, and they can be in the form of a desktop application or a web application. FIG. 2 shows an example of a conventional electronic calendar. As can be seen in FIG. 2, in this calendar view, the scope is one month, and is primarily displaying the month of May. A month view is equivalent to a five week view displayed in a grid format. In this grid format, the spacing between the horizontal and vertical lines do not need to be completely uniform. Each day in the calendar view has its own day container. In this example, each day container is essentially a square. The last day of April and the first few days of June can also be seen in this conventional electronic calendar 200. The user has the ability to scroll forward or backwards in time by clicking on the back scroll 220 or forward scroll 210. The scroll will usually scroll in increments of a week or a month. In addition to the calendar view having a scope of one month, showing a scope of one day, one week, two weeks, three weeks, four weeks, and so on are also possible.

The conventional electronic calendar is used for keeping track of events. Some example events are lunch appointments, meetings, birthdays, and trips. The conventional use for the electronic calendar is to record an event into the calendar so that the user is able to keep track of what appointments and commitments the user has for any given date. An event is entered with a start date and end date. It may also include a start time and end time if the event is not all day.

FIG. 3 provides a view of a conventional electronic calendar with four events entered by the user. The events shown in the conventional electronic calendar 300 as displayed as event overlays, and are “Meeting” 310, “Lunch” 320, “Camping with family” 330, and “Wedding” 340. The start time and end time are not displayed in this view, but could be. In this example view 300, the user may have a meeting with a co-worker at 3 pm on May 10^{th}, and would enter it into the conventional electronic calendar. Once entered, it would appear graphically as an event overlay within the May 10^{th} day container as seen in the “Meeting” event overlay 310. The same user may have a lunch appointment with a friend at 12 pm on May 14^{th}, which can be seen in the “Lunch” event overlay 320 within the May 14^{th} day container. The same user may be leaving for a camping trip with the family from May 18 until May 20, without specifying any start or end time. This is seen in the “Camping with family” event overlay 330 which spans across three day containers: May 18^{th}, May 19^{th}, and May 20^{th}. Finally, the user may have a wedding to attend on May 27^{th} from 2 pm until 5 pm, and this is displayed as the “Wedding” event overlay 340 within the May 27^{th} day container.

### SUMMARY OF THE INVENTION

The present invention provides a system for creating and utilizing an electronic location calendar. An electronic location calendar is much like a conventional electronic calendar, but instead of displaying events, as a conventional electronic calendar would, the electronic location calendar displays a user's location for any given date and time. Many views are possible with an electronic location calendar, including day view, week view, and month view.

An electronic location calendar is capable of displaying dates and times for the past, present, and future. Accordingly, it is capable of displaying a user's location for the past, present, and future.

A user's particular location at any particular date and time takes into consideration the user's current home location, previous home locations, along with the user's past and future travels.

Through the use of an electronic location calendar, travelers will be able to more easily discover where related individuals were, is, and will be geographically located. A related individual is an individual with whom the traveler has a relationship with, such as a friend of the traveler, a relative of the traveler or a business associate of the traveler. A related individual can also include a friend of a friend. Using an electronic social network, the traveler will identify related individuals with zero degree of separation, and perhaps their category (such as friend, family, or co-worker). The traveler's related individuals will inform the system of their present and future whereabouts. This will allow the traveler to discover where related individuals are currently located, and where they will be located for any given future date. The traveler can also inform the system about his/her current and future whereabouts, and let the system determine which related individuals will be nearby for the present and future respectively.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a flowchart diagram of the prior art.

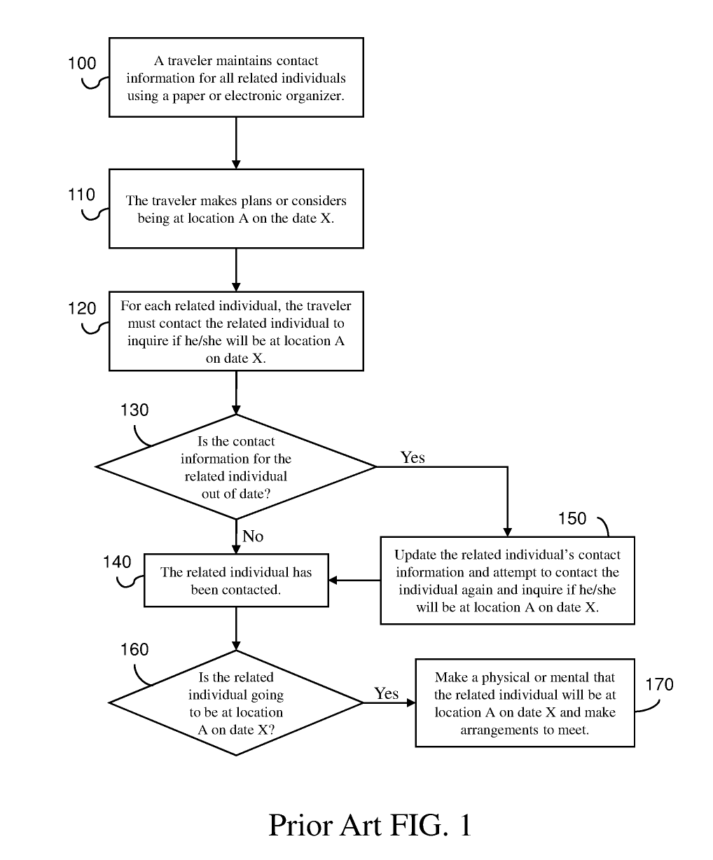

FIG. 2 is a view of a conventional electronic calendar.

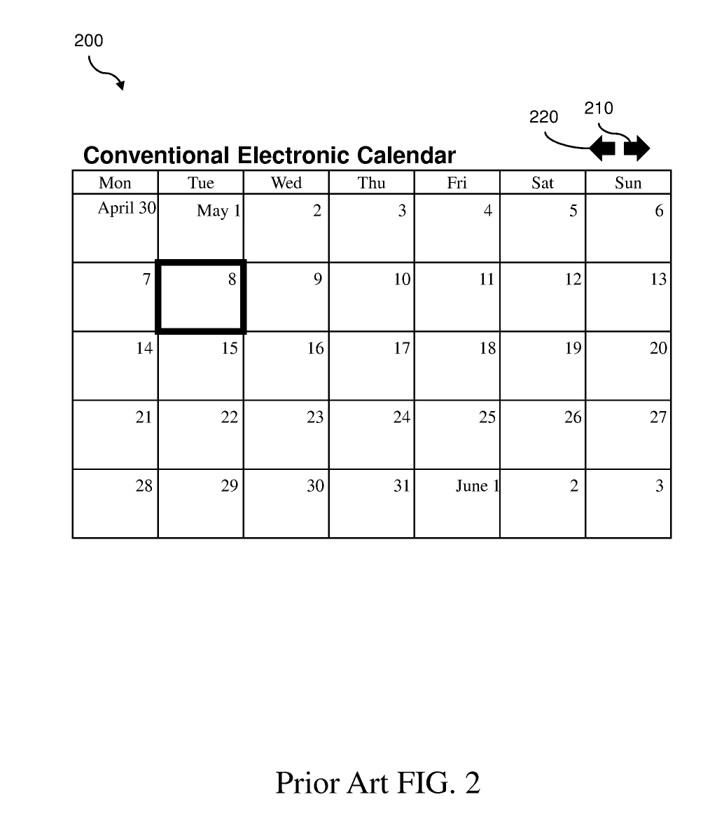

FIG. 3 is a view of a conventional electronic calendar.

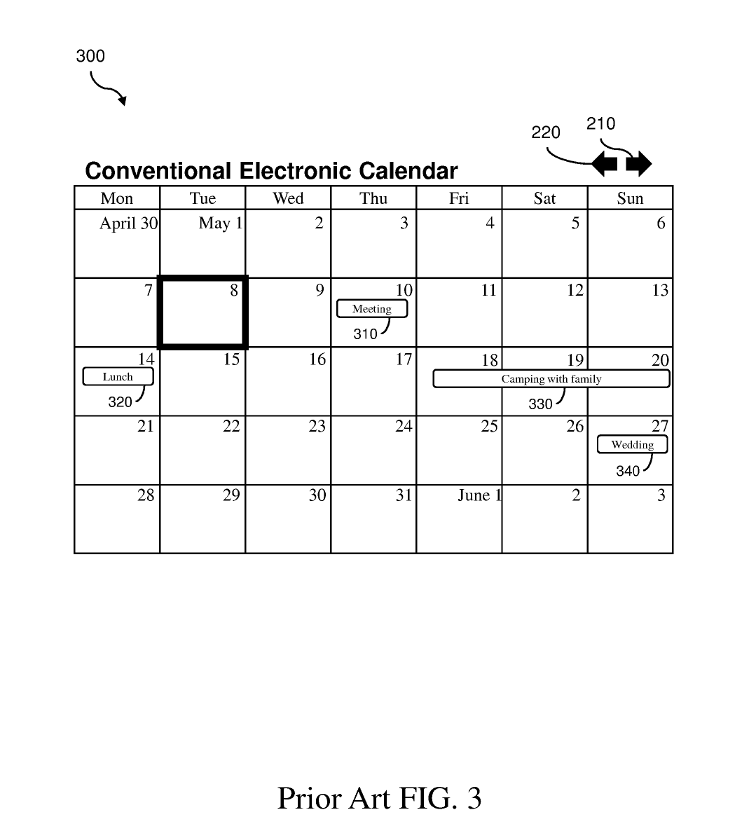

FIG. 4a is relationship diagram of an electronic social network.

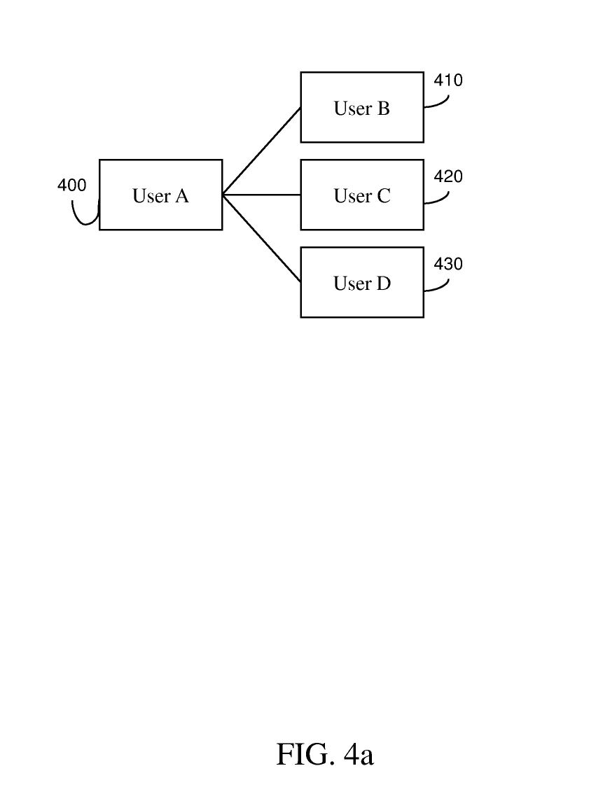

FIG. 4b is relationship diagram of an electronic social network.

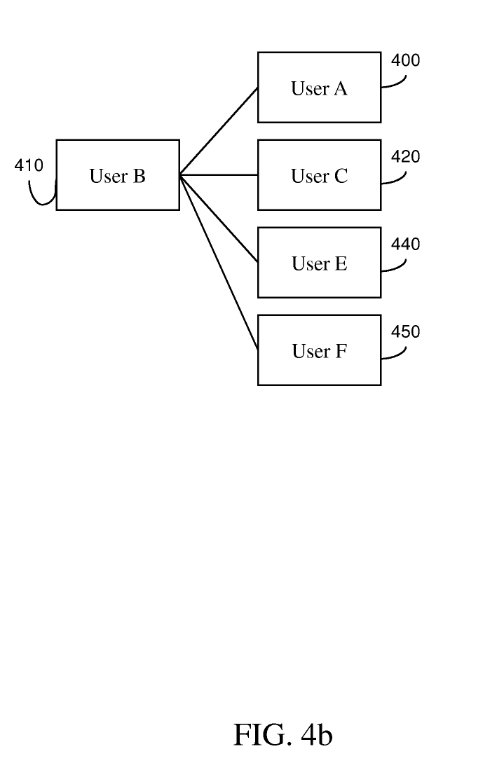

FIG. 4c is relationship diagram of an electronic social network.

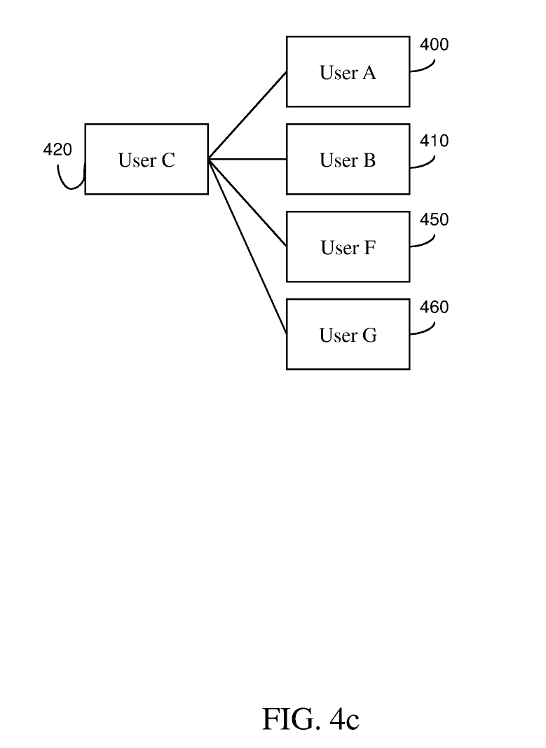

FIG. 4d is relationship diagram of an electronic social network.

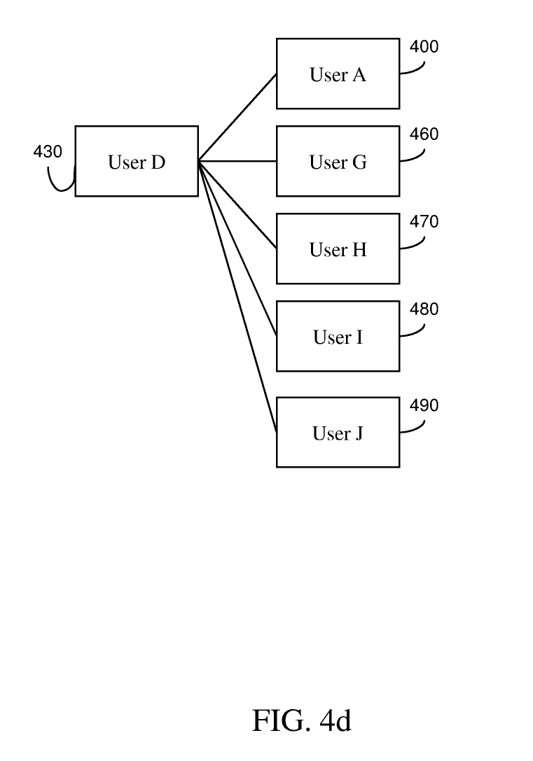

FIG. 4e is relationship diagram of an electronic social network.

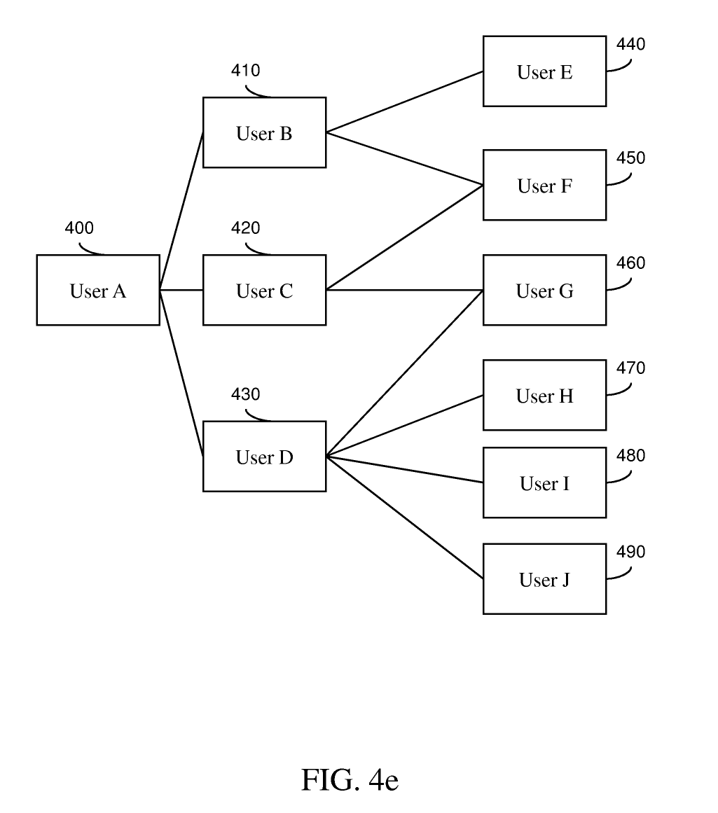

FIG. 5 is a flowchart diagram of an embodiment of the present invention.

FIG. 6 is a technical block diagram of an embodiment of the present invention.

FIG. 7 is a detailed technical block server diagram of an embodiment of the present invention.

FIG. 8 is a user interface diagram for inputting a user's future travel plans.

FIG. 9 is a view of an electronic location calendar.

FIG. 10 is a view for reporting the location of related individuals that can be met for a particular trip.

FIG. 11 is a user interface diagram for querying the location of related individuals for a particular date.

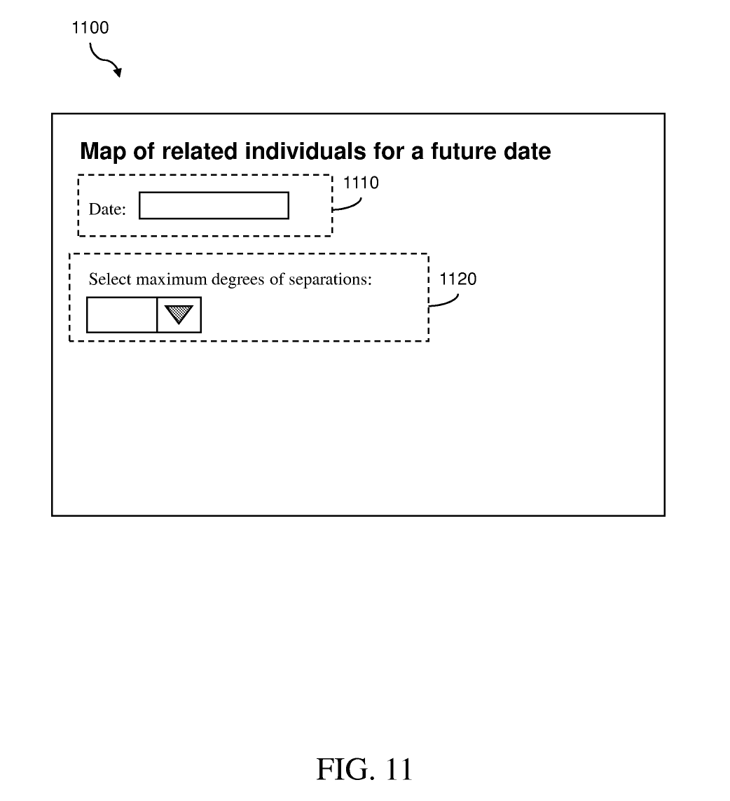

FIG. 12 is a map view for reporting the location of related individuals.

### DETAILED DESCRIPTION OF THE PREFERRED EMBODIMENTS

System Overview

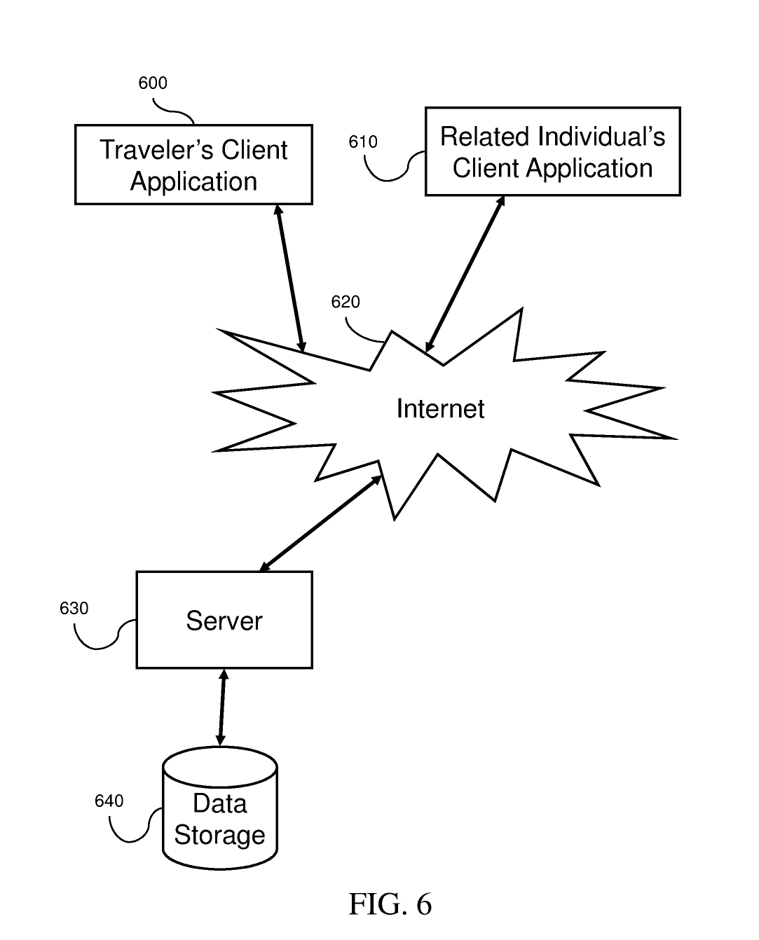

FIG. 6 is a high level technical diagram of an embodiment of the present invention. A traveler interacts with the system by using a client application 600 which is connected to the internet 620 and communicates with the server 630. Similarly, one or more related individual of the traveler also uses a client application 610 which is connected to the internet 620 and communicates with the server 630. The server 630 contains application logic for inputting travel plans and using this data for advanced reporting. The server 630 is also used to manage all logic involved with an electronic social network. All persistent data is stored by the server 630 onto a data storage device 640 such as a database.

Methodology

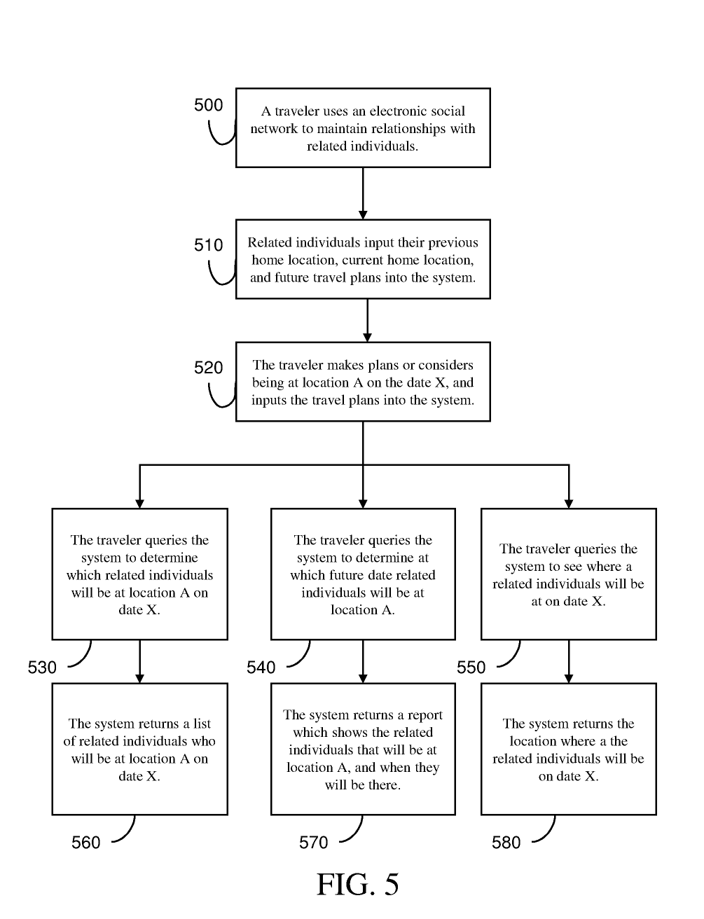

FIG. 5 is a flow chart of an embodiment of the present invention. In the first step 500, a traveler uses a client application 600 to interface with an electronic social network running on the server 630 to maintain his/her relationship with related individuals. Data about the traveler and related individuals, along with their relationships are persisted in the data storage device 640. In the next step 510, related individuals, using a client application 610, input their previous home location, current home location, and future travel plans into the system, which ultimately gets registered by the server 630 and stored onto the data storage 640. Related individuals are able to add, remove, and edit future travel plans. Related individuals can also modify their current and previous home locations.

In step 520, the traveler makes plans to travel or is considers traveling. The traveler's destination or intended destination, if any, is designated as location A on the date X. The traveler enters this information into the system via the client application 600.

With travel plans in mind, the traveler may be curious about which related individuals he/she can meet with while at location A. In this system, the traveler is able to query for this information in three different fashions. First is via step 530 whereby the traveler queries the system to determine which related individuals will also be at location A on date X. In step 560, the system returns a list of all related individuals who will be at location A on date X. The system will return an empty list if it cannot find any related individuals that will also be at location A on date X.

The second means by which the traveler can query the system is via step 540 whereby the traveler queries the system to discover when in the future related individuals will be at location A. If the traveler is flexible, the traveler will be able to use this information to influence when the traveler decides to travel to location A. In step 570, the system returns a report revealing the related individuals who will be at location A sometime in the future, and the dates when they will be at location A.

The third means by which the traveler can query the system is via step 550 whereby the traveler queries the system to see where related individuals will be on date X. This allows the traveler to see where the traveler's related individuals will be for a future date. In step 580, the system returns with information revealing the location of related individuals for date X. This can be displayed in a list format or can be displayed on a map for easier viewing.

### COMPREHENSIVE EXAMPLE

FIG. 6 shows at a high level how the users interact with the system of this invention, and how different pieces of the system are interconnected. The traveler interacts with this system via a client application 600, and similarly, the related individuals interact with this system via a client application 610. The traveler's client application 600 and related individuals' client application 610 both connect to a server 630 by going over the internet 620. The server 630 uses a data storage device 640 for data persistence.

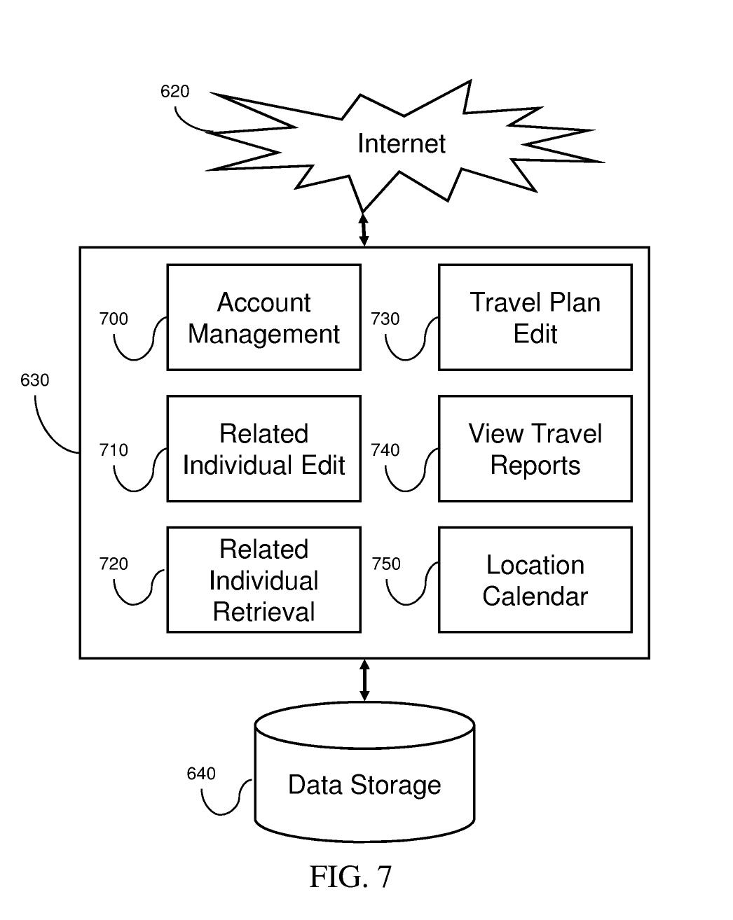

FIG. 7 is a detailed technical diagram of an embodiment of the present invention. The server 630 contains several modules where business logic resides for handling an electronic social network and for handling travel related functions. The business logic modules responsible for the electronic social network include Account Management 700, Related Individual Edit 710, and Related Individual Retrieve 720. The modules responsible for the travel related functions include Travel Plan Edit 730, View Travel Reports 740, and Location Calendar 750.

The Account Management module 700 is used to manage basic account features for each member of the electronic social network. Basic account features include creating a new account, modifying an existing account, logging into an existing account, and removing an existing account. Some properties of an account include username, password, first name, last name, address, phone number, photos, interests, work information, email address, and credit card information. In terms of location, the account may also hold previous home location(s) data and current home location data. There may be multiple previous home location data for a user. For example, a user may have lived in Los Angeles, Calif. from Jan. 10, 1986 until Mar. 20, 1997, and San Francisco, Calif. from Mar. 21, 1997 until Sep. 5, 2006. There is a single current home location data for a user. For example, a user may have a current home location of Seattle, Wash., starting from Sep. 6, 2006. Anytime a user performs account related functionality, it is the responsibility of the Account Management module 700 to handle the request. Account information is persisted on the data storage 640.

The Related Individual Edit module 710 allows a member of the electronic social network to add a relationship to a related individual, edit a relationship to a related individual, and remove a relationship to a related individual. Typically, in order to have a relationship to a particular related individual on the electronic social network, that particular related individual must be a member and have an account set up with the electronic social network. The electronic social network member uses the Related Individual Edit module 710 to manage only related individuals within zero degree of separation from the member. The electronic social network member need not manage related individuals within degrees of separation of one or more, as this is handled by the system automatically. Relationships to a related individual are persisted on the data storage 640.

The Related Individual Retrieval module 720 handles the request of returning a list of related individuals for a particular member. The request may specify the degrees of separation. For example, a social network member may request all related individuals within zero degree of separation, which would prompt module 720 to return all related individuals for which the social network member has a direct relationship with. In another example, a social network member may request all related individuals within one degree of separation, which would prompt module 720 to return all related individuals for which the social network member has a direct relationship with, along with all related individuals that they have a direct relationship with.

The Travel Plan Edit module 730 allows a member of the social network to add a travel plan, edit a travel plan, and remove a travel plan. A travel plan includes properties such as the beginning date and time, ending date and time, destination, and purpose of travel. It may also include a specific event that the user is attending, such as a concert, tradeshow, conference, or other group activities. This data could be used for allowing users to discover each other that are attending the same event. A travel plan may also include transit information. For example, if the traveler is flying to the destination, the traveler may also enter information about the flight, including airline, flight number, departure date and time, departure airport, arrival date and time, and arrival airport. This would be entered once for the transit to the destination, and again for the transit back home. If the traveler is visiting multiple destinations, the traveler may enter multiple destinations, and accordingly, multiple transit information. All travel plan data is persisted on the data storage 640 connected to the server 630.

The View Travel Reports module 740 is responsible for handling various requests related to discovering the location of a related individual for a future date. There are three major types of request that the module 740 can accept. First is a request for all related individuals at a specified location for a specified date. Second is the location of related individuals for a specified date. Third is the future date when a related individual will be at a specified location.

The Location Calendar module 750 is responsible for putting a user's travel plans into a graphical, electronic location calendar. The location calendar will display a user's location for the past, present and future, and will utilize data collected by the Travel Plan Edit module 730. The information includes travel plans, previous home location(s), and current home location. The Location Calendar module 750, using complex algorithms, will utilize this information to determine where the user is at any point in time. Logically, the user cannot be in two different locations at the same date and time. For example, Location Calendar module 750 will intelligent know that the user is at the current location for a future date and time, unless there is a travel plan that takes the user somewhere else. If there is transit information for the travel plan, the Location Calendar module 750 will realize that during transit, the user is not in any particular location. On a side note, for transit, the system could discover a related individual on the same transit and inform the user of this.

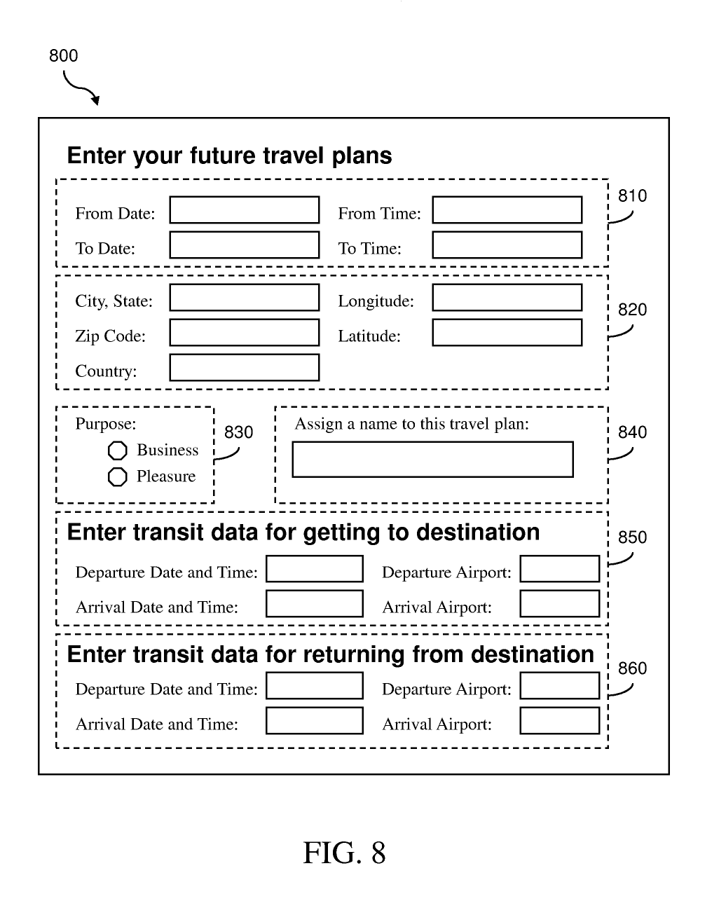

FIG. 8 shows a user interface to enter their future travel plans. This user interface would be displayed on the traveler's client application 600 or the related individuals' client application 610. The traveler and related individuals are able to enter their future travel plans using this interface, which accomplishes step 510 and step 520. On this user interface 800, users can enter the date and time range 810 for their future travel plan, the location where they will be traveling to 820, plus the transit information 850 860. Travel location can be entered using a variety of information, such as city, state, and country, or zip code, or even the longitude and latitude as seen in 820. Transit information can be entered for the transit to the destination 850 and transit returning from the destination 860. In addition to capturing the transit start date/time, end date/time, departure airport, and arrival airport, other data such as the airline, flight number, and such could also be collected. Transit does not necessarily have to be an airline flight, and as such, other data could also be collected which would be relevant to travel by train, boat, or other means.

In user interface 800, the purpose for travel 830 is also selectable, and a name 840 can be assigned to each travel plan entered.

Privacy is also a very important consideration. Often times, a user may not want to disclose a particular travel plan, previous location, or current location to certain people. In order to protect the user's privacy, the system will allow the user to specify the privacy setting at a very granular level. In this embodiment, the privacy settings include: public, system member, extended network, immediate network, and specific categories within the immediate network. Public means the information is viewable by anyone. System member means that the information is viewable only by others who have an account on the system. Extended network means the information is viewable only by related individuals who are at most 1 degree of separation apart. Immediate network means the information is viewable only by related individuals who are 0 degrees of separation apart. Finally, categories within the immediate network means the information is viewable only by a subset of the immediate network. For example, the user is able to categorize related individuals within his/her immediate network as “Friends”, “Family”, or “Co-Workers”.

The user is able to specify a privacy setting for each individual trip. For a user's trip to New York, the user may only want “Friends” and “Family” members to see this trip, whereas for a trip to Chicago, the user may allow the entire public to see this trip. The user is also able to specify a privacy setting for the previous and current home location.

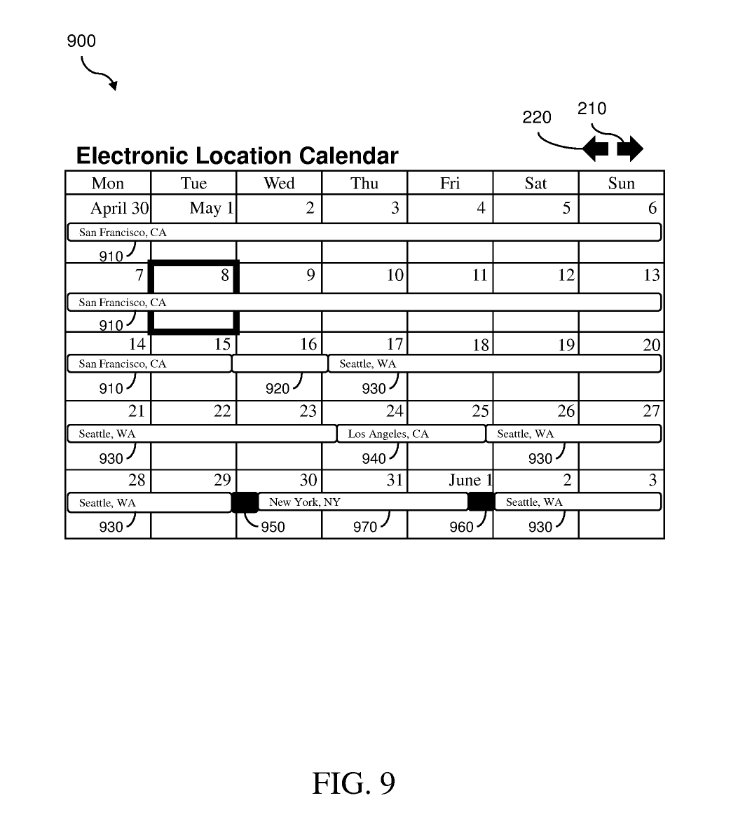

Based on the travel plan data entered by the user in FIG. 8, and the data collected about the user's previous home locations and current home location by the Account Management module 700, the Location Calendar module 750 is able to draw a graphical representation of the user's location via an electronic location calendar 900. FIG. 9 shows an electronic location calendar for a particular user in the month of May. As can been seen, the electronic location calendar draws the calendar itself much like a convention electronic calendar would. The primary difference is that the electronic location calendar will has specialized logic to properly draw location overlays.

There are multiple types of location overlays. In this embodiment, four types of location overlays are described, which include home location overlay, destination location overlay, empty location overlay, and transit location overlay. Home location overlay is used to represent the location of the user based on the previous home location and current home location. The destination location overlay is used to represent the location of the user when the user is traveling. An empty location overlay is utilized when the system is unable to determine the location of the user for any period in time. Transit location overlay is used to represent the time when the user is in transit for travel.

In the example on FIG. 9, let's assume that today is May 28^{th}. The user specified a previous home location of San Francisco, Calif. from January 15^{th} until May 15^{th} at 11 pm. So on the electronic location calendar 900, we see San Francisco, Calif. 910 as a home location overlay. On the electronic location calendar 900, the San Francisco, Calif. home location overlay 910 spans across a range of visible day containers, specifically, April 30^{th} to May 15^{th}. Although the user's previous home location of San Francisco, Calif. spans from January 15^{th} until May 15^{th}, the electronic location calendar 900 can only display the home location overlay 910 for the visible dates. Thus, only visible day containers, April 30^{th} through May 15^{th}, will show the San Francisco, Calif. home location overlay 910. The user also specified that the user's current home location is Seattle, Wash., and that the user has been at this home location starting at 2 pm on May 17^{th}. This is represented graphically in the Seattle, Wash. home location overlay 930. As can be seen on the calendar, the system does not know where the user was between May 15^{th}, 11 pm and May 17^{th}, 2 am. This is referred to as dead-time, and graphically represented with an empty location overlay 920. Since the user's current home location is Seattle, Wash., the system assumes that this will be the user's home location in the future as well.

The user entered two travel plans. One which is now in the past (prior to May 28^{th}), and one that is in the future (after May 28^{th}). The first travel plan has a destination of Los Angeles, Calif., from May 24^{th} at 6 am until May 25^{th} at 10 pm. We see this in the Los Angeles, Calif. destination location overlay 940. The user did not specify any transit information for this travel plan. The second travel plan has a destination of New York, N.Y., with a start date/time of May 29^{th} at 11 pm and end date/time of June 2^{nd} at 12 am. We see this in the New York, N.Y. destination location overlay 970 which spans across three day containers, May 30^{th}, May 31^{st}, and June 1^{st}. In this second travel plan, the user has entered transit information for going to the destination and returning from the destination. The user is in transit to the destination from May 29^{th} at 11 pm until May 30^{th} at 5 am, which is shown in the transit location overlay 950. The user is in transit from the destination, returning back home, from June 1^{st} at 7 pm until June 2^{nd} at 12 am, which is shown in the transit location overlay 960. This means the user is at the destination, New York, from May 30^{th}, 5 am until June 1^{st}, 7 pm, as seen in the New York, N.Y. destination overlay 970.

In this embodiment of the electronic location calendar 900, each day container is assumed to be vertically partitioned into twenty four hours. This allows for display of location overlays to be vertically shifted by time. For example, the May 30^{th} date cell shows a destination of New York, N.Y. starting at 5 am. This is expressed by starting the New York, N.Y. destination location overlay 970 about 5/24 or about 21% to the right of the left edge of the May 30^{th} date cell. If the New York, N.Y. destination location overlay 970 was supposed to begin at 12 pm on May 30^{th}, it would be drawn as starting right in the center of the May 30^{th} date cell, since 12/24 is 50%. This method provides the viewer with a quick approximate visual of the time.

In this embodiment of the electronic location calendar, all dates and times are displayed using a single, default time zone. This helps to avoid confusion and overlap of location overlays. To make it more convenient for the user to enter information such as transit start date/time, transit end date/time, travel plan start date/time, and travel plan end date/time, the system may allow the user to specify the time zone for the date/time entered, and the system can convert the entered date/time into the default time zone for display on the electronic location calendar. It is advantageous for the system to keep the entered time zone specified by the user for future display purposes, such as when the user decides to make an edit to an existing travel plan.

Also notice that the system recognized that the Seattle, Wash. home location overlay 930 had to be segmented because of the user's travel to Los Angeles, Calif. and New York, N.Y. As visually displayed in the Seattle, Wash. home location overlay 930, the user is not in Seattle, Wash. while in transit or at a travel destination. There are four possible outcomes with a home location overlay is segmented by a travel plan. The home location overlay may result in zero segments, meaning that a travel plan ranges all dates that the home location overlay does. In other words, the start date/time for the travel plan is equal to or earlier than the start date/time for the home location overlay, and the end date/time for the travel plan is equal to or later than the end date/time for the home location overlay. The home location overlay may result in one segment, with the start date/time set to a later date/time than the original home location overlay. This happens when the travel plan start date/time is less than or equal to the home location overlay start date/time, the travel plan end date/time is later than the home location overlay start date/time, and the travel plan end date/time is earlier than the home location overlay end date/time. The home location overlay may result in one segment, with the end date/time set to an earlier date/time than the original home location overlay. This happens when the travel plan start date/time is later than the home location overlay start date/time, the travel plan start date/time is earlier than the home location overlay end date/time, and the travel plan end date/time is later than or equal to the home location overlay end date/time. Finally, the home location overlay may result in two segments. This happens when the travel plan start date/time is later than the home location overlay start date/time and the travel plan end date/time is earlier than the home location overlay end date/time.

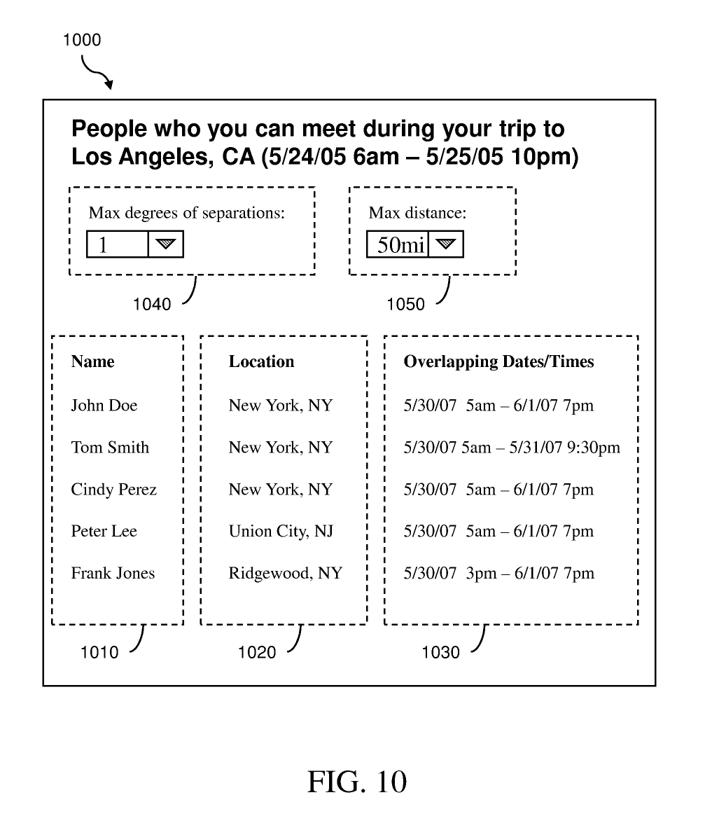

In step 530, the traveler is able to discover related individuals in the same future location at the same future date and time. This can be easily done by clicking on the destination of a travel plan on the electronic location calendar 900. As mentioned, the user is traveling to New York, N.Y. The user can click on this destination 970 on the electronic location calendar 900, and the system will search for all related individuals that will be near New York, N.Y. between May 30^{th}, 5 am, and June 1^{st}, 7 pm. This list is shown on FIG. 10. The traveler is also able to specify the maximum degrees of separation to search for via the drop down 1040. For example, if the traveler chooses “0” as a selection here, the system will limit search results to only related individuals with zero degrees of separation from the traveler. The traveler is also able to specify the maximum distance a related individual can be from the traveler by entering the maximum distance in the drop down 1050. The search result includes the related individual's name 1010, along with the location where the related individual will be located 1020. The search result also shows the specific future dates 1030 for when these related individuals will be in location specified in 1020. This search result satisfies step 560.

Another way of searching is by date rather than by destination. The user can click on a particular date on the electronic location calendar 900 and see which related individuals will be nearby on that given date. For example, the user may click on May 8^{th}. Although this is in the past, the functionality will be the same. By clicking on May 8^{th}, the system will recognize that the user was in San Francisco, Calif. on that date, and will show the user a list of related individuals who were nearby to San Francisco, Calif. on that date.

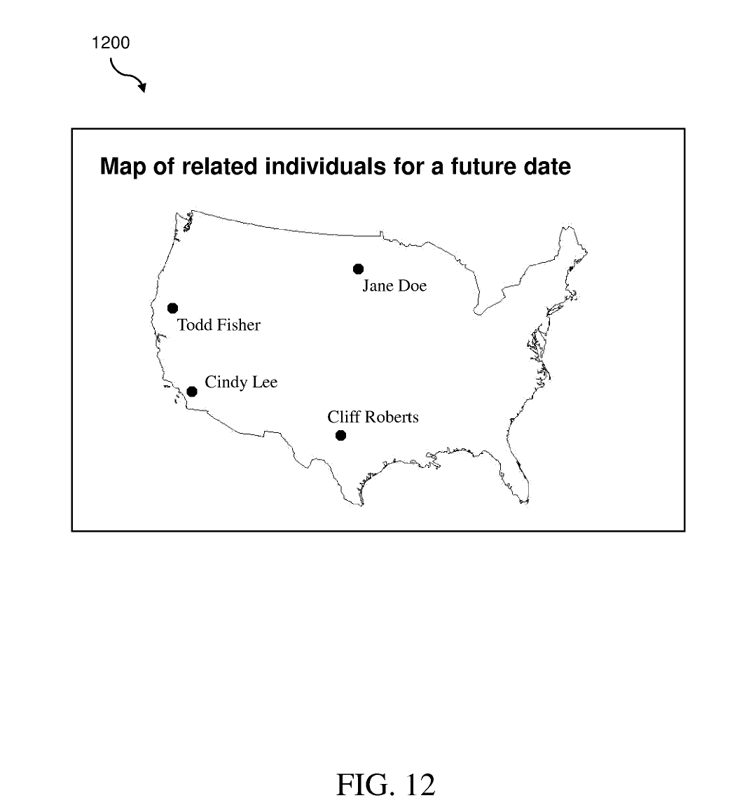

In step 550, the traveler is able to query the system to see where related individuals will be at on a future date. One method of doing so is by simply view the related individual's electronic location calendar. Another method is via the user interface 1100 allows the traveler to specify a future date 1110, and the maximum degrees of separation 1120. FIG. 12 shows a graphical search result for the query submitted from the user interface 1100. FIG. 12 shows where each related individual will be for the future date specified. Each related individual is plotted on a map, which provides a much more user friendly view for the traveler. The map may be customized to show the entire globe, or to be zoomed into one geographical area. This search result satisfies step 580.

With such a system, a traveler is given the opportunity to efficiently schedule meetings and get together with related individuals. These related individuals, as mentioned earlier, may be friends, co-workers, business associates, relatives, etc. The advantage of being able to meet with a related individual while traveling may be advantageous from a business viewpoint, and may also make the travels more enjoyable. In many cases, travelers will find themselves scheduling their travel plans around their related individuals' travel plans. The system allows for this capability as well. With this system, travelers will no longer have to miss an opportunity to meet and get together with related individuals. With this system, travelers will no longer waste time seeking related individuals when planning to travel.

Although the present invention has been described in detail with respect to certain embodiments and examples, variations and modifications exist which are within the scope of the present invention as defined in the following claims.

What is claimed:

1. A graphical user interface for an electronic location calendar, comprising:
a calendar view;
a destination location overlay displayed on said calendar view, said destination location overlay's placement and sizing is determined by a start date and an end date for a travel plan associated with said destination location overlay, where said destination location overlay is displayed within visible day containers between said start date and said end date.

2. The graphical user interface as defined by claim 1 further comprising of a home location overlay displayed on said calendar view.

3. The graphical user interface as defined in claim 2 wherein said home location overlay is representative of a previous home location and a current home location.

4. The graphical user interface as defined in claim 2 wherein said home location overlay is segmented if said destination location overlay overlaps with said home location overlay.

5. The graphical user interface as defined in claim 1 further comprising of a transit location overlay displayed on said calendar view.

6. The graphical user interface as defined in claim 1 further comprising of an empty location overlay displayed on said calendar view.

7. The graphical user interface as defined in claim 1 wherein said destination location overlay placement and sizing is determined by said start date, a start time, said end date, and an end time for said travel plan associated with said destination location overlay, wherein said destination location overlay is vertically shifted in start day container and end day container to visually represent the said start time and said end time.

8. The graphical user interface as defined in claim 1 wherein said calendar view has a scope of one month.

9. The graphical user interface as defined in claim 1 further comprising of an event overlay displayed on the said calendar view.

10. A method for determining a user's location and generating a graphical user interface for display, comprising the steps of:
inputting a travel plan for said user, said travel plan comprising of start date, end date, and destination;
displaying a calendar view with a destination location overlay associated with said travel plan, where said destination location overlay is displayed within visible day containers between said start date and said end date.

11. The method of claim 10 wherein said travel plan further comprises of start time and end time.

12. The method of claim 10 wherein said travel plan further comprises of transit information.

13. The method of claim 12 further comprising the step of displaying transit location overlay.

14. The method of claim 10 further comprising the step of inputting previous home location and current home location for said user.

15. The method of claim 14 further comprising the step of displaying home location overlay.

16. The method of claim 15 wherein said displaying home location overlay is segmented if said destination location overlay overlaps with said home location overlay.

17. The method of claim 10 further comprising the step of displaying empty location overlay.

18. The method of claim 10 wherein said destination location overlay's display size and position is determined by said start date, a start time, said end date, and an end time for said travel plan, wherein said destination location overlay is vertically shifted in start day container and end day container to visually represent the said start time and said end time.

19. The method of claim 10 further comprising the step of displaying an event overlay.
